(19) United States
(12) Patent Application Publication
(10) Pub. No.: US 2014/0129246 A1
(43) Pub. Date: May 8, 2014

(54) Extension of clinical guidelines based on clinical expert recommendations

(71) Applicants: Richard Vdovjak, Eindhoven (NL); Anca Ioana Daniela Bucur, Eindhoven (NL)

(72) Inventors: Richard Vdovjak, Eindhoven (NL); Anca Ioana Daniela Bucur, Eindhoven (NL)

(73) Assignee: KONINKLIJKE PHILIPS ELECTRONICS N.V., EINDHOVEN (NL)

(21) Appl. No.: 14/065,596

(22) Filed: Oct. 29, 2013

(30) Foreign Application Priority Data
Nov. 7, 2012 (EP) 12191613.4

(51) Int. Cl. G06F 19/00

(52) U.S. Cl. CPC G06F 19/322; G06F 19/3425
USPC 705/2

(57) ABSTRACT

A clinical decision support system comprises a clinical guideline (1) extended with expert recommendations. At least one of the nodes (3) is associated with a pair (4) of a clinical question (5) and a corresponding clinical answer (6), the pair forming an extension to the clinical guideline (1) for the purpose of the clinical decision support. A node unit (7) is arranged for determining a node (3) of the plurality of nodes, based on a condition of a specific patient and the set of clinical preconditions of the node. A presenting unit (8) is arranged for presenting at least a part of the pair (4) of the question (5) and/or the corresponding clinical answer (6) associated with the relevant node (3). A matching unit (10) is arranged for matching a question against a collection of existing questions previously answered, in dependence on the relevant node (3).

### FIELD OF THE INVENTION

The invention relates to a clinical decision support system.

### BACKGROUND OF THE INVENTION

In healthcare, issues of increasing importance are reducing the expenses, and increasing the quality, safety and efficiency of care. Additionally, there is a widening knowledge gap between the care provided in top research clinical sites and standard care sites, which may result in differences in treatments and outcomes. In this context, there is a need to bring the latest therapy options to as many hospitals as possible.

Electronic health record (EHR) systems are currently being widely implemented to help manage patient records, increase the ability of analysts to assess quality of healthcare, and reduce patient sufferance due to medical errors. Clinical decision support tools help leverage the value of the data collected in EHR systems. Such tools may allow doctors to use the data in the patient file and combine it with clinical knowledge to make the best available patient-specific decisions. Moreover, clinical recommendations or specific advice provided by clinical experts to their colleagues form another means of knowledge dissemination. Also, patients may ask for a second opinion. Such consultations can take place face-to-face or via messages.

US 2008082358 A1 discloses a method comprising: receiving user-provided clinical information during a first clinical decision support event associated with a patient; comparing the user-provided clinical information with the patient against one or more rules for initiating one or more clinical decision support events; generating a user interface for the second clinical decision support event, including user-provided clinical information from the first clinical decision support event and stored clinical information; providing clinical advice based on further user-provided clinical information, the user-provided clinical information from the first clinical decision support event, and the stored clinical information.

US 2012101845 A1 discloses a method comprising: selecting a patient condition for management based on at least one evidence-based clinical practice guideline; reviewing, using a processor, evidence-based studies and clinical practice guidelines to form a starting point for medical support; reviewing an existing workflow; creating a modified workflow, associated decision support; developing a guideline-assisted medical support process; and providing the guideline-assisted medical support process to a user for usage and review.

### SUMMARY OF THE INVENTION

It would be advantageous to provide an improved clinical decision support system. To better address this concern, a first aspect of the invention provides a system comprising

at least one clinical guideline comprising a plurality of nodes, wherein a node is associated with a set of clinical preconditions and a clinical recommendation, and wherein the node is further associated with a pair of a clinical question and a corresponding clinical answer, the pair forming an extension to the clinical guideline;

a node unit for determining a relevant node of the plurality of nodes, based on a condition of a specific patient and the set of clinical preconditions of the relevant node;

a presenting unit for presenting at least a part of the pair of the question and/or the corresponding clinical answer associated with the relevant node.

Since the number of clinical experts in most clinical domains is small, their time is an expensive resource which should be managed efficiently. The system provides a way to reuse recommendations by experts, i.e. clinical answers, when they become generally relevant to different patients. It will be understood that the clinical answer may take the form of any kind of clinical recommendation that corresponds to the clinical question. The clinical question may for example include information relating to a condition of a patient and/or an indication of the desired clinical information.

Clinical experts may collect the data they provide during second opinion or consultation encounters: the question, the patient data, the answer, and clinical evidence that supports the answer. This information may be stored in the patient record of the patient to whom the question relates.

However, advantageously, by associating the questions and their answers to a relevant node of a clinical guideline in accordance with the invention, relevant clinical answers may be found more easily for any patient, with reduced or eliminated waiting time.

Extending guidelines with information obtained from new expert recommendations that are collected during clinical practice enables the system to provide the most accurate recommendation for a case based both on standard guidelines, on specific expert recommendations (e.g. in more complex cases), and on the most recently available knowledge. For example, the guidelines may be extended on-the-fly as new recommendations become available.

Of a direct benefit for a healthcare organization is to use the knowledge provided by the experts it hires to improve the care provided by all the clinicians in the organization (including education of the young physicians). This may be achieved by augmenting the clinical guidelines in use at the organization with relevant knowledge out of expert recommendations. The augmented guidelines can also be used by other healthcare organizations to improve their standard of care For example, a community hospital could increase their quality of care and reduce the gap compared to a top academic center by using a clinical decision support system that incorporates clinical answers to clinical questions that were answered in the past. The system may provide a mechanism or a formally established channel for transferring best practices to clinicians of a particular specialty.

The system may comprise:

a question unit for receiving an input clinical question in respect of a patient; and

a matching unit for matching the question against a corpus of existing questions previously answered, to find a matching question that is similar to the input clinical question according to a predetermined similarity measure;

wherein the presenting unit is arranged for, if a matching question is found, presenting the clinical answer corresponding to the matching question from the corpus of existing questions.

Thus, if a treating physician has a clinical question relating to a particular patient, for example a question regarding the treatment options for the patient, the question may be asked by the physician by providing the question to the question unit. However, the question does not need to be forwarded to a human expert, in case the answer to a similar question is already available at a relevant node in the guideline. This way, less work is needed, and/or the answer to the question may be obtained more quickly. More than one similarity measure may be evaluated. The similarity measure may be based on information extracted from several sources, such as questions, answers, or patient data.

The system may further comprise an adding unit for, if no matching question is found, retrieving a clinical answer corresponding to the clinical question from an expert, and adding the question and the clinical answer retrieved from the expert to the corpus of questions. If a question is asked for which no matching question/answer pair is found, then the question may be forwarded for processing by a human expert. This way, in principle any question can be answered.

The adding unit may be arranged for associating the pair added to the corpus of questions with the relevant node in view of the condition of the patient to which the clinical question relates. This is a useful way to find the relevant node in the guideline with which a question/answer pair may be associated.

The adding unit may be arranged for adding a new node to the plurality of nodes based on the clinical answer retrieved from the expert, wherein the new node is indicative of a set of clinical preconditions extracted from the clinical question and/or the clinical answer. This may be useful to further integrate the knowledge represented by the clinical question and/or answer into the guideline. For example, when a recommendation (question-answer pair) prescribes the evaluation of a new patient condition or the collection of additional patient information, this may be consolidated in the guidelines by adding a new node.

The system may comprise a feedback unit for, if a matching question is found, determining whether the clinical answer corresponding to the matching question is appropriate, and if the clinical answer is found to be inappropriate for the patient to which the clinical question relates, triggering the adding unit to retrieve a clinical answer corresponding to the question from an expert, and add the question and the corresponding clinical answer retrieved from the expert to the corpus of questions. Even if a new question matches an existing question/answer pair, it is possible that the existing answer does not provide a sufficient answer to the new question. For example, in such a case, the physician who asked the new question may provide such feedback, so that the question is forwarded to an expert.

The system may comprise a first alert unit for generating an alert if no matching question is found, to indicate to the expert that a clinical answer corresponding to the clinical question is requested; and/or a second alert unit for generating an alert directed to a user who inputted the input clinical question, in response to the adding unit retrieving the clinical answer from the expert. This way, users of the system get alerted when an action is expected from them.

The system may comprise

a condition unit for extracting information relating to a clinical condition of a patient from a clinical question and/or a corresponding clinical answer and/or a patient health record;

a question-node unit for determining a particular node of the plurality of nodes, wherein the extracted clinical condition of the patient matches the set of clinical preconditions of the particular node according to a set of predetermined matching criteria;

an associating unit for associating the clinical question and the corresponding clinical answer with the particular node.

This allows an existing question/answer pair to be analyzed and matched to a node of the guideline, so that the guideline can be extended by associating the question/answer pair to that node of the guideline. This way, for example, a bulk of existing question/answer pairs may be added to the guideline.

The system may comprise a question normalizing unit for normalizing a question by generating a formal representation of the question based on a predetermined terminology and syntax. This allows new and old questions to be matched with each other more reliability and/or efficiency, because the standardized representation makes it easier to compare the questions. Also other processing operations may be implemented in a streamlined way, when the questions have been normalized to a standardized format.

The system may comprise a health record unit for retrieving information relating to the condition of the specific patient from an electronic health record. This information may be used, for example, to enrich the question with more patient-specific information. This additional information may be used to find similar questions, to provide the human expert with more information, and/or to be able to find a node with which to associate a question/answer pair with more accuracy.

In another aspect, the invention provides a workstation comprising a system set forth herein.

In another aspect, the invention provides a method of providing clinical decision support, comprising associating a set of clinical preconditions and a clinical recommendations with a node of a clinical guideline including a plurality of nodes; associating a pair of a clinical question and a corresponding clinical answer with the node, wherein the pair forms an extension of the clinical guideline; determining a relevant node of the plurality of nodes, based on a condition of a specific patient and the set of clinical preconditions of the relevant node; and presenting at least a part of the pair of the question and/or the corresponding answer associated with the relevant node.

In another aspect, the invention provides a computer program product comprising instructions for causing a processor system to perform a method set forth herein.

It will be appreciated by those skilled in the art that two or more of the above-mentioned embodiments, implementations, and/or aspects of the invention may be combined in any way deemed useful.

Modifications and variations of the workstation, the method, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated hereinafter with reference to the drawings.

FIG. 1 shows a diagram of a part of a clinical guideline.

FIG. 2 shows a diagram of a clinical decision support system.

FIG. 3 shows a flowchart illustrating aspects of a method of building an extension of a clinical decision support system,

### DETAILED DESCRIPTION OF EMBODIMENTS

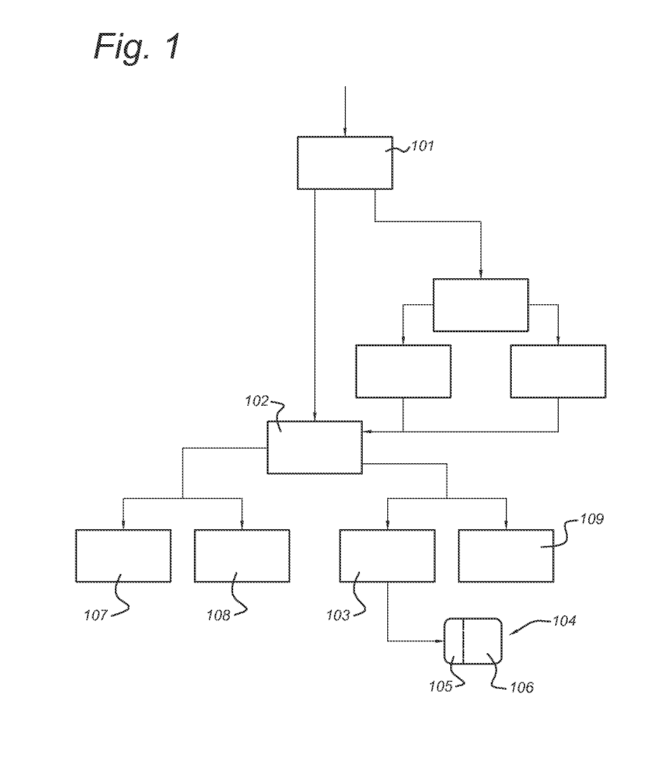

FIG. 1 depicts, schematically, a small fragment of a clinical guidelines decision tree for early breast cancer. Guidelines are used to support clinicians in the patient management and are elaborated based on various types of evidence (clinical trials, state of art practice, expert opinion). Several computerized guideline systems exist that allow the clinician to navigate through the decision tree. A possible implementation of a clinical guideline is by means of a decision tree or graph that can also be represented as a Resource Description Framework (RDF) graph. Other implementations using other formalisms are also possible.

In the drawing, nodes 101 are represented by rectangles. The details of the nodes, such as a specification of clinical preconditions and a clinical recommendation, have not been indicated in the drawings. Each node, such as 101, 102, 103, represents a set of clinical preconditions on a patient, as well as a recommendation as to how to proceed. For example, nodes 101 and 102 indicate that, depending on the patient condition, node 107, 108, 103, or 109 is relevant. Node 103, for example, may recommend a particular treatment or test.

However, sometimes the details of the patient's condition may not match entirely with the information in the clinical guidelines, or the treating physician may have further questions that he or she is not able to answer based on the guidelines. In such a case the treating physician may formulate a question directed to a clinical expert.

The decision graph or tree may be extended by associating to each node, where available, a list of links to relevant clinical consultation questions and the corresponding expert recommendations (clinical answers). The length of the list of such expert recommendations for each node depends on the number of distinct questions submitted for expert review that are related to that node. These questions can usually be linked to uncertainties concerning the decision in particular nodes in the guidelines: exceptions, variations in treatments, adverse events, patients with co-morbidities, etc. The decision graph/tree can also be extended with new nodes based on new data items and conditions provided by the expert recommendations.

By addressing these complex cases by making use of the recommendations of the experts, the system may provide more detailed and up-to-date knowledge, while improving the efficiency of care and of the consultation process.

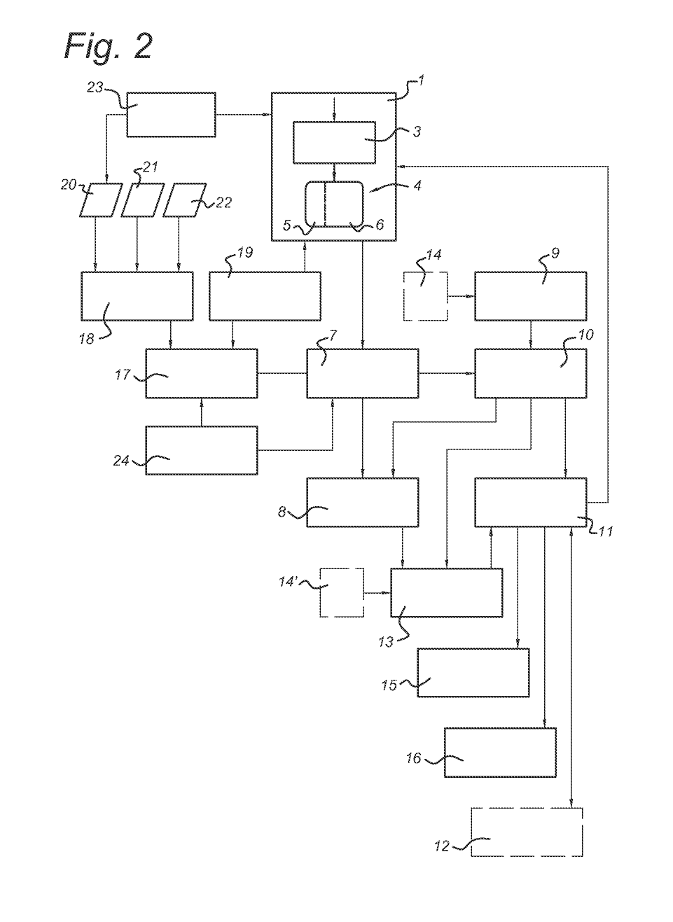

FIG. 2 illustrates aspects of a clinical decision support system. The system may be implemented on many different hardware platforms, such as a distributed computer system or a standalone workstation.

The system may comprise a clinical guideline 1. More than one clinical guideline may be present in the system. The techniques disclosed herein may be applied to all guidelines in the system, or to only one or a subset of the guidelines that are present in the system. For clarity, only one clinical guideline 1 is shown in FIG. 2. The system may select a relevant guideline automatically, or enable manual selection of a guideline to use. The guideline 1 may comprise a plurality of nodes 101, 102, 109, as described in more detail hereinabove with reference to FIG. 1. For reasons of clarity, FIG. 2 only illustrates one node 3 of the plurality of nodes of the guideline 1. A node 3 may be associated with a set of clinical preconditions and a clinical recommendation. The clinical preconditions of a node may follow in part or entirely from the position of the node in the tree. Other representations of nodes, not in a tree, are also possible. For example, a statistical or otherwise computational classification system may be used to determine the relevancy of a particular recommendation (node). Consequently, the scope is not limited to a clinical guideline that is organized in form of a decision tree.

At least one of the nodes 3 may be associated with a pair 4 of a clinical question 5 and a corresponding clinical answer 6. The clinical answer 6 may have the form of a clinical recommendation corresponding to the clinical question 5. The pair 4 forms an extension to the clinical guideline 1, because the pair 4 is associated with a node 3 of the clinical guideline.

The system may comprise a node unit 7 arranged for determining a relevant node 3 of the plurality of nodes, based on a condition of a specific patient and the set of clinical preconditions of the relevant node. Features of this node unit 7 may be implemented in a way known in the art per se.

The system may further comprise a presenting unit 8 arranged for presenting at least a part of the pair 4 of the question 5 and/or the corresponding clinical answer 6 associated with the relevant node 3. For example, the presenting unit 8 may be arranged for presenting the recommendation of the relevant node 3 for a patient, and a list of question/answer pairs that are associated with the relevant node 3. Such a list may be displayed automatically, for example, or triggered by a user input. The presenting unit 8 may be arranged for displaying or otherwise presenting the clinical answer 6 in response to a user selecting a pair 4 for presentation. The presenting unit 8 may also be arranged for automatically presenting any available pairs associated with the relevant node 3.

The system may further comprise an automatic relevant pair determination unit (not shown), arranged for matching the information in the pairs with the information known about the patient. The presenting unit 8 may be arranged for automatically presenting at least part of a question/answer pair when it matches the information known about the patient according to a set of matching criteria.

The system may comprise a question unit 9 for receiving an input clinical question in respect of a patient. This question may be input by a user 14, for example. This question unit 9 may be arranged, for example, to accept a question after the relevant node 3 has been established and optionally the recommendation of the node 3 has been presented.

The system may comprise a matching unit 10 for matching the question against a collection of existing questions previously answered, in dependence on the relevant node 3. For example, the matching unit 10 may evaluate the questions associated with the relevant node 3 and/or nodes that are closely related to the relevant node 3 according to predetermined criteria. The matching unit 10 seeks a matching question 4 that is similar to the input clinical question according to one or a plurality of predetermined similarity measures. The presenting unit 8 may be arranged for, if a matching question 5 is found, presenting the clinical answer 6 corresponding to the matching question 5 from the collection of existing questions.

It is noted that the collection of existing pairs of questions and answers may be stored in a separate data structure, such as a table or a database, wherein associative links are created between pairs and nodes. Alternatively, the collection of existing pairs may be integrated into the guideline 1 by embedding the information of each pair into a node of the clinical guideline. Other arrangements are also possible.

The system may comprise an adding unit 11 arranged for, if no matching question is found, retrieving a clinical answer corresponding to the clinical question from an expert 12. This may be performed in many different ways, for example by sending a message to an expert through a messaging system or by setting a flag in the system that causes a user interface to generate a signal indicative of an open question. Such a signal may be noted by a personnel member who may then forward the question to an appropriate expert. The adding unit 11 may be arranged for adding the question and the clinical answer retrieved from the expert to the collection of questions. The adding unit 11 may be arranged for associating the pair 4 added to the collection of questions with the relevant node 3 in view of the condition of the patient to which the clinical question relates.

The system may comprise a feedback unit 13 arranged for, if a matching question 4 is found, determining whether the clinical answer 5 corresponding to the matching question 4 is appropriate. For example, the user may believe that the answer is not relevant, not accurate, outdated, or otherwise inappropriate to answer the specific question of the user. In case the clinical answer is found to be inappropriate for the patient to which the clinical question relates, the feedback unit may trigger the adding unit 11 to retrieve a clinical answer corresponding to the question from an expert, and add the question and the corresponding clinical answer retrieved from the expert to the collection of questions.

The system may comprise a first alert unit 15 arranged for generating an alert if no matching question is found, to indicate that a clinical answer corresponding to the clinical question is requested. Alternatively or additionally, the system may comprise a second alert unit 16 arranged for generating an alert directed to a user 14′ who inputted the input clinical question, in response to the adding unit retrieving the clinical answer from the expert.

The system may comprise a condition unit 18 arranged for extracting information relating to a clinical condition of a patient from a clinical question 20 and/or a corresponding clinical answer 21. For example, this information may be obtained from the standardized representation of the question and/or answer. The system may comprise a question-node unit 17 arranged for determining a particular node 3 of the plurality of nodes. The particular node 3 is selected such that the extracted clinical condition of the patient matches the set of clinical preconditions of the particular node 3 according to a set of predetermined matching criteria. The system may further comprise an associating unit 19 arranged for associating the clinical question 21 and the corresponding clinical answer 22 with the particular node 3. For example, a link is created or the question and answer are embedded into the clinical guideline at the particular node 3.

The system may comprise a question normalizing unit 23 arranged for normalizing a question 20 by generating a formal representation of the question 23 based on a predetermined terminology and syntax. For example, natural language processing is used to replace synonyms by a standard term and to translate natural language text into structured form.

The system may comprise a health record unit 24 arranged for retrieving information relating to the condition of the specific patient from an electronic health record. This information may be used to find the most relevant node 3, for example, or to add additional information to a question.

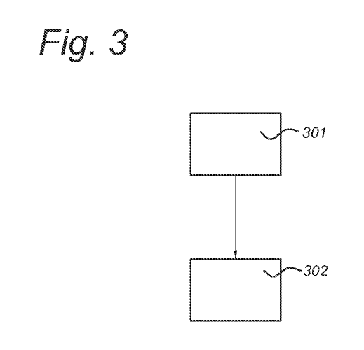

FIG. 3 illustrates a method of handling an extension of a clinical decision support system, wherein a clinical guideline 1 of the clinical decision support system comprises a plurality of nodes, wherein a node 3 is associated with a set of clinical preconditions and a clinical recommendation, wherein at least one of the nodes is associated with a pair 4 of a clinical question 5 and a corresponding clinical answer 6, the pair 4 forming an extension of the clinical guideline 1. The method comprises determining 301 a relevant node of the plurality of nodes, based on a condition of a specific patient and the set of clinical preconditions of the relevant node. The method further comprises presenting 302 at least a part of the pair of the question and/or the corresponding answer associated with the relevant node. The method may be extended or modified based on the description of the system. The method may be implemented as a computer program.

The current computerized clinical guidelines typically are an implementation of the paper guidelines and are usually updated with a significant delay (on average 1-2 years) compared to the latest available knowledge. Known guidelines typically focus on the generic patient and are not applicable in all difficult, complex or non-standard cases.

Additionally, even in a top healthcare center, experts are few and their time is a scarce and expensive resource. It is also relevant for healthcare organizations to become able to reuse the knowledge and data in their systems to reduce costs, avoid medical errors, or improve efficiency. A method and a system that provides an efficient dissemination of the expert knowledge through the augmented clinical guidelines to all healthcare professionals in the organization would be helpful in this respect.

Expert knowledge may be captured in the clinical recommendation/advice process in the context of clinical consultations. In current practice, this is focused on individual cases and there is no link to the guidelines to identify missing information and no possibility to reuse that expert recommendation for other patients.

The content of the questions may be formalized in a way that supports automatic evaluation and that makes it easier to link questions to specific recommendation documents based on their semantic content.

However, questions may be provided in free text form. Extracting meaning form free text is a computer science problem often referred to as Natural Language Processing (NLP). The use of free text in the healthcare domain is frequent and extracting the semantics from such text is a technology that may be used to provide more intelligent clinical decision support systems. While using NLP techniques can enable to detect concepts and even in particular cases their relationships, comparing a large number of free text narratives (such as the questions for clinical consultations) is a large computational task when those narratives are described in natural language. To improve the quality of the guidelines or the clinical workflow, the expert recommendations may be linked to the nodes in the guidelines where they are relevant, as disclosed herein. For example, an expert recommendation concerning the handling of an adverse event for a particular treatment would become an extension of the node in the guidelines recommending that treatment. A recommendation describing how to interpret a borderline value of a particular test may be linked to both the node in the guidelines that suggests that test and to the node(s) that indicate the patient stratification based on that test.

Free text narratives, as those represented by questions for clinical expert recommendations and corresponding clinical documents providing an expert recommendation in reply to the question with respect to diagnosis or treatment in a patient case, may be linked to relevant nodes in the clinical guidelines graph.

In a particular example, a system may comprise a domain ontology that defines a standardized terminology used in a knowledge domain. The system may further comprise a clinical expert recommendations system comprising a repository of clinical questions represented for example as an (RDF) graph, a repository of clinical documents/recommendations, and a subset of the terminology containing the concepts relevant for the guidelines and the clinical recommendations. The clinical documents/recommendations may be associated with a timestamp of each document and authorship information: electronic signature or name of the expert who provided the recommendation.

The system may also comprise a repository of relevant patient data that was used to provide the recommendations. The system may comprise an NLP pipeline arranged for processing a question entered by the user and convert it into a set of canonical, or standardized, terms (out of the domain ontology) and patterns (e.g. chosen sub-sentences, regular expressions, etc.). The system may comprise a matcher used to match clinical consultation records to the nodes in the guidelines that they could extend. The system may comprise a computerized clinical guidelines system that is arranged for being extended by including links to clinical questions and expert recommendations in response to the questions. The system may also comprise a visualization module enabling the browsing of the extended guidelines.

In the following, an example of a method of using the system is described. From the questions in the available recommendations database, any redundant/non-informative parts may be removed. A semantic graph may be made of a question and/or corresponding recommendation by extracting the relevant set of concepts and patterns present in the narrative and building the relations among them and identifying the instances. Synonyms may be detected and replaced with the canonical terms. This graph containing canonical terms and defined patterns is a conceptual representation of the information need of the user. The documents may be retrieved from the EHR or in a separate repository. The system may extract the relevant information and store it in a suitable format in a repository controlled by the system.

A new question introduced by the user may be processed through the NLP pipeline as described above, and then it may be compared to the existing questions. If a suitable existing question is found, the corresponding answer/recommendation may be linked to the new question. If a matching existing question is not found, the question may be added to the corresponding repository and submitted to the expert for feedback.

The relevant nodes in the clinical guidelines, to which the extension in form of the question and/or corresponding recommendation is linked, may be computed in dependence on the available patient data and the semantic content of the patient data.

When a recommendation is provided by the expert, in answer to the question/request, the document holding the recommendation may be added to the repository of recommendations together with a time stamp, authorship information, and a link to the question that initiated the recommendation and the corresponding patient data. If the recommendations are stored directly in the EHR, the data can also be fed in a repository that is connected to the clinical guideline system.

In an example implementation, at deployment the repositories are built as follows. First one or more databases of questions and recommendations are built based on retrospective data (all qualifying past recommendations stored in a legacy consultation system or in the EHR). Each question may be associated with a patient file. Therefore, selected patient data may be used to provide a context for the query. Based on the workflow, this data may be considered sufficient to allow the expert to provide a recommendation. Hereinafter, this patient data may be referred to as the patient record, although it may in fact be a structured subset of the complete patient record in the EHR. The linked question may be stored, for example, as free text or as a semantic graph.

Both the structured patient data and the clinical question may be annotated with concepts from the domain terminology. This metadata may be stored and used to find relevant nodes in the guidelines. The NLP pipeline may be used to extract concepts out of free text data.

In the simplest case, just by restructuring the available data, each patient record and associated question can link to exactly one expert recommendation. In a more complex implementation an additional step may compare questions and recommendations, group similar questions and corresponding recommendations together and eliminate redundant questions. The expert recommendations may be stored as free text or in another representation, including a structured data format. The authorship and timestamp metadata may also be stored.

Next, each qualifying node of the guidelines may be annotated with the same chosen domain terminology. Some guidelines systems may already make use of standard terminologies. In other cases, the nodes may be annotated with a representation using such standard terminologies.

Next, a matcher may be run on the semantic metadata extracted from expert recommendations (the concepts in the pairs of (patient record, question)) and on the nodes of the guidelines. The guidelines nodes and the recommendation records that for which a matching measure is above a desired threshold are linked, i.e. an identifier of (pointer to) the recommendation record may be added to the list of extensions associated to the node.

An additional step of manual verification and/or editing can be performed, for example at the end, to verify the result of the matching and improve the accuracy and relevance of the lists of extensions. When desired, the thresholds of the matcher can be changed and the algorithm re-run.

New questions from the consultation process may first be passed through the NLP pipeline and/or annotated with concepts from the domain terminology. Alternatively, the questions are entered in a structured and/or standardized way. They may be then compared with the semantic metadata of existing questions. When a match is found, the corresponding record and document is presented to the user as recommendation.

A validation/user feedback mechanism can also be included, in which the clinical user confirms or rejects the system suggestion (enabling evaluation and learning). If the suggestion is rejected, the new question is added to the repository and submitted to the expert to provide a recommendation.

The visualization module may enable the users to browse through the extended guidelines together with the relevant context information, e.g. the user can check for expert recommendations included who was the expert providing the advice and what was the relevant patient data (to decide whether this is indeed relevant for own case).

The current computerized clinical guidelines typically are an implementation of the paper guidelines and are usually updated with a significant delay (on average 1-2 years) compared to the latest available knowledge. Guidelines typically focus on the generic patient and are not applicable in all difficult, complex or non-standard cases. Additionally, even in a top healthcare center, experts are few and their time is a scarce and expensive resource.

It is also relevant for healthcare organizations to become able to reuse the knowledge and data in their systems to reduce costs, avoid medical errors, or improve efficiency. A method and a system that provides an efficient dissemination of the expert knowledge through the augmented clinical guidelines to all healthcare professionals in the organization would be helpful in this respect.

Expert knowledge may be captured in the clinical recommendation/advice process in the context of clinical consultations. In current practice, this is focused on individual cases and there is no link to the guidelines to identify missing information and no possibility to reuse that expert recommendation for other patients.

The content of the questions may be formalized in a way that supports automatic evaluation and that makes it easier to link questions to specific recommendation documents based on their semantic content.

However, questions may be provided in free text form. Extracting meaning form free text is a computer science problem often referred to as Natural Language Processing (NLP). The use of free text in the healthcare domain is frequent and extracting the semantics from such text is a technology that may be used to provide more intelligent clinical decision support systems. While using NLP techniques can enable to detect concepts and even in particular cases their relationships, comparing a large number of free text narratives (such as the questions for clinical consultations) is a large computational task when those narratives are described in natural language. To improve the quality of the guidelines or the clinical workflow, the expert recommendations may be linked to the nodes in the guidelines where they are relevant. For example, an expert recommendation concerning the handling of an adverse event for a particular treatment would become an extension of the node in the guidelines recommending that treatment. A recommendation describing how to interpret a borderline value of a particular test may be linked to both the node in the guidelines that suggests that test and to the node(s) that indicate the patient stratification based on that test.

Free text narratives, as those represented by questions for clinical expert recommendations and corresponding clinical documents providing an expert recommendation with respect to diagnosis or treatment in a patient case, may be linked to relevant nodes in the clinical guidelines graph.

In a particular example, a system may comprise a domain ontology that defines a standardized terminology used in a knowledge domain. The system may further comprise a clinical expert recommendations system comprising a repository of clinical questions represented for example as an (RDF) graph, a repository of clinical documents/recommendations, and a subset of the terminology containing the concepts relevant for the guidelines and the clinical recommendations. The clinical documents/recommendations may be associated with a timestamp of each document and authorship information: electronic signature or name of the expert who provided the recommendation.

The system may also comprise a repository of relevant patient data that was used to provide the recommendations. The system may comprise an NLP pipeline arranged for processing a question entered by the user and convert it into a set of canonical, or standardized, terms (out of the domain ontology) and patterns (e.g. chosen sub-sentences, regular expressions, etc.). The system may comprise a matcher used to match clinical consultation records to the nodes in the guidelines that they could extend. The system may comprise a computerized clinical guidelines system that is arranged for being extended by including links to clinical questions and expert recommendations in response to the questions. The system may also comprise a visualization module enabling the browsing of the extended guidelines.

In the following, an example of a method of using the system is described. From the questions in the available recommendations database, any redundant/non-informative parts may be removed. A semantic graph may be made of a question and/or corresponding recommendation by extracting the relevant set of concepts and patterns present in the narrative and building the relations among them and identifying the instances. Synonyms may be detected and replaced with the canonical terms. This graph containing canonical terms and defined patterns is a conceptual representation of the information need of the user. The documents may be retrieved from the EHR or in a separate repository. The system may extract the relevant information and store it in a suitable format in a repository controlled by the system.

A new question introduced by the user may be processed through the NLP pipeline as above, and then it may be compared to the existing questions. If a suitable existing question is found, the corresponding answer/recommendation may be linked to the new question. If a matching existing question is not found, the question may be added to the corresponding repository and submitted to the expert for feedback.

The relevant nodes in the clinical guidelines, to which the extension in form of the question and/or corresponding recommendation is linked, may be computed in dependence on the available patient data and the semantic content of the patient data.

When a recommendation is provided by the expert, in answer to the question/request, the document holding the recommendation may be added to the repository of recommendations together with a time stamp, authorship information, and a link to the question that initiated the recommendation and the corresponding patient data. If the recommendations are stored directly in the EHR, the data can also be fed in a repository that is connected to the clinical guideline system.

It will be appreciated that the invention also applies to computer programs, particularly computer programs on or in a carrier, adapted to put the invention into practice. The program may be in the form of a source code, an object code, a code intermediate source and an object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a flash drive or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A clinical decision support system, comprising
at least one clinical guideline (1) comprising a plurality of nodes, wherein a node (3) is associated with a set of clinical preconditions and a clinical recommendation, wherein the node (3) is further associated with a pair (4) of a clinical question (5) and a corresponding clinical answer (6), the pair forming an extension to the clinical guideline (1);
a node unit (7) for determining a relevant node (3) of the plurality of nodes, based on a condition of a specific patient and the set of clinical preconditions of the relevant node;
a presenting unit (8) for presenting at least a part of the pair (4) of the question (5) and/or the corresponding clinical answer (6) associated with the relevant node (3).

2. The system according to claim 1, further comprising
a question unit (9) for receiving an input clinical question in respect of a patient;
a matching unit (10) for matching the question against a collection of existing questions previously answered, in dependence on the relevant node (3), to find a matching question (4) that is similar to the input clinical question according to a predetermined similarity measure;
wherein the presenting unit (8) is arranged for, if a matching question (5) is found, presenting the clinical answer (6) corresponding to the matching question (5) from the collection of existing questions.

3. The system according to claim 2, further comprising an adding unit (11) for, if no matching question is found, retrieving a clinical answer corresponding to the clinical question from an expert (12), and adding the question and the clinical answer retrieved from the expert to the collection of questions.

4. The system according to claim 3, wherein the adding unit (11) is arranged for associating the pair (4) added to the collection of questions with the relevant node (3) in view of the condition of the patient to which the clinical question relates.

5. The system according to claim 3, wherein the adding unit is arranged for adding a new node to the plurality of nodes based on the clinical answer retrieved from the expert, wherein the new node is indicative of a set of clinical preconditions extracted from the clinical question and/or the clinical answer.

6. The system according to claim 3, further comprising a feedback unit (13) for, if a matching question (4) is found, determining whether the clinical answer (5) corresponding to the matching question (4) is appropriate, and if the clinical answer is found to be inappropriate for the patient to which the clinical question relates, triggering the adding unit (11) to retrieve a clinical answer corresponding to the question from an expert, and add the question and the corresponding clinical answer retrieved from the expert to the collection of questions.

7. The system according to claim 3, further comprising
a first alert unit (15) for generating an alert if no matching question is found, to indicate that a clinical answer corresponding to the clinical question is requested; and/or
a second alert unit (16) for generating an alert directed to a user (14′) who inputted the input clinical question, in response to the adding unit retrieving the clinical answer from the expert.

8. The system according to claim 1, further comprising
a condition unit (18) for extracting information relating to a clinical condition of a patient from a clinical question (20) and/or a corresponding clinical answer (21) and/or a patient health record;
a question-node unit (17) for determining a particular node (3) of the plurality of nodes, wherein the extracted clinical condition of the patient matches the set of clinical preconditions of the particular node (3) according to a set of predetermined matching criteria;
an associating unit (19) for associating the clinical question (21) and the corresponding clinical answer (22) with the particular node (3).

9. The system according to claim 2 or 8, further comprising a question normalizing unit (23) for normalizing a question (20) by generating a formal representation of the question (23) based on a predetermined terminology and syntax.

10. The system according to claim 1, further comprising a health record unit (24) for retrieving information relating to the condition of the specific patient from an electronic health record.

11. A workstation comprising the system according to claim 1.

12. A method of providing clinical decision support, comprising
associating a set of clinical preconditions and a clinical recommendations with a node (3) of a clinical guideline (1) including a plurality of nodes;
associating a pair (4) of a clinical question (5) and a corresponding clinical answer (6) with the node (3), wherein the pair (4) forms an extension of the clinical guideline (1);
determining (301) a relevant node of the plurality of nodes, based on a condition of a specific patient and the set of clinical preconditions of the relevant node; and
presenting (302) at least a part of the pair of the question and/or the corresponding answer associated with the relevant node.

13. A computer program product comprising instructions for causing a processor system to perform the method according to claim 12.
